(19) United States
(12) Patent Application Publication
(10) Pub. No.: US 2005/0030905 A1
(43) Pub. Date: Feb. 10, 2005

(54) Wireless communication device with status display

(76) Inventors: Chih-Wei Luo, Ying Ke Town (TW); Wen-Bin Tsai, Kang San Town (TW)

Correspondence Address: PRO-TECHTOR INTERNATIONAL, 20775 Norada Court, Saratoga, CA, 95070-3018, US

(21) Appl. No.: 10/638,142

(22) Filed: Aug. 7, 2003

(51) Int. Cl. H04L 12/26

(52) U.S. Cl. 370/253; 370/310

(57) ABSTRACT

A wireless communication device has a wireless transceiver module, a calculation module and a display module. The wireless transceiver module transmits and receives wireless data. The calculation module retrieves and processes the wireless data for generating display instructions. The display module shows communication status of the wireless communication device according to the display instructions. With information regarding the communication status, users are able to know the instant status of the wireless communication device.

### BACKGROUND OF THE INVENTION

1. Field of Invention

The present invention relates to a wireless communication device. More particularly, the present invention relates to a wireless communication device with status display.

2. Description of Related Art

Networks are more and more important today. For example, people use e-mail, seek jobs, collect information and look for entertainment via various kinds of networks. Wireless communication, as well as wide bandwidth, provides different ways to elevate the convenience of networks.

Most architecture of wireless networks nowadays adopts an AP (Access Point) for serving a number of client electronic devices, such as personal computers, notebooks, personal digital assistants (PDAs), mobile phones, etc. There are various kinds of APs, ranging from basic hubs, routers, to high-end gateways with functions of different levels. However, all such wireless devices, like hubs, routers or gateways, suffer from the instability of wireless communications and confined bandwidth. Network administrators therefore need to manage such devices carefully. For example, additional APs may need to be installed if a network is often congested.

Accordingly, it is necessary to know instant statuses of wireless networks. However, wireless network management nowadays is performed by complicated software, and it costs much and is too complicated for home users or company users.

Thus, it is very attractive to provide a mechanism that shows instant statuses of networks because such a mechanism will make wireless communication more convenient and add increase the value of such wireless communication devices.

### SUMMARY OF THE INVENTION

The present invention is directed to a wireless communication device with status display so that network administrators or normal users are able to realize the instant operation statuses of the wireless communication device. Accordingly, network administrators or normal users can act in response to manage the wireless communication device.

The wireless communication device has a housing, a wireless transceiver module, a calculation module, and a display module. The wireless module, the calculation module and the display module are installed in the housing, and the wireless transceiver receives and transmits data according to at least one wireless communication protocol. The calculation module is coupled to the wireless transceiver module for intercepting an amount of transmitted or received data and calculates an instant flow rate of the wireless transceiver module. In addition, the calculation module generates a display instruction according to the instant flow rate and the wireless communication protocol. The display module shows instant flow status according to the display instruction.

In addition, the calculation module also intercepts other parameters of transmitted data, e.g. an interval flow rate and a signal quality, and generates corresponding display instructions, respectively. Thus, a sleep status and a signal quality status are presented to users. It is to be understood that both the foregoing general description and the following detailed description are for examples, and are intended to provide further explanation of the invention as claimed.

### BRIEF DESCRIPTION OF THE DRAWINGS

The invention can be more fully understood by reading the following detailed description of the preferred embodiment, with reference made to the accompanying drawings as follows:

FIG. 1 is a functional block diagram of an embodiment according to the present invention;

FIG. 2 is a preferred embodiment according to the present invention;

FIG. 3 is a schematic external view of the preferred embodiment;

FIG. 4 is an internal operation diagram of the preferred embodiment;

FIG. 5(a)-(d) are various examples of display lights according to the present invention; and

FIG. 6 is a schematic diagram showing another preferred embodiment.

### DESCRIPTION OF THE PREFERRED EMBODIMENTS

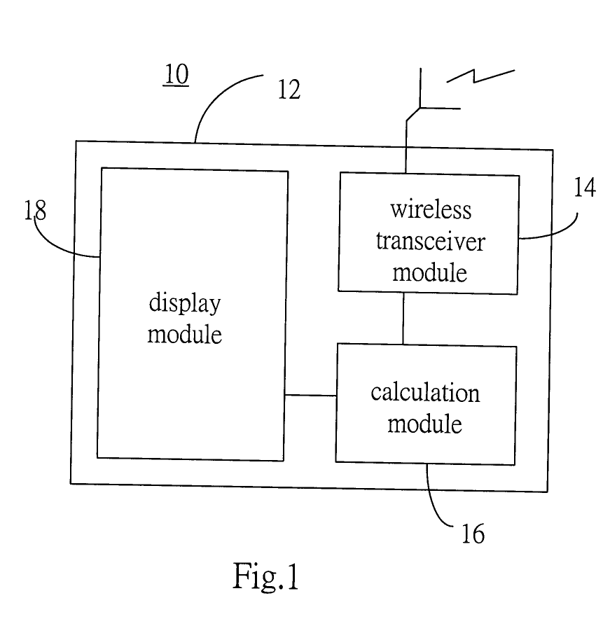

FIG. 1 is a functional block diagram of an embodiment according to the present invention. Wireless communication device 10 has a housing 12, one or more wireless transceiver modules 14, a calculation module 16, and a display module 18. The wireless transceiver module 14, the calculation module 16, and the display module 18 are installed in housing 12.

The wireless transceiver module 14 transmits data to and receives data from the one or more wireless electronic devices, and the data are transmitted under a certain wireless protocol. Such electronic devices include notebooks, desktop computers, personal digital assistants (PDA), mobile communication devices, gateways, routers, and bridges, for example.

The calculation module 16 is coupled to the wireless transceiver module 14, and the calculation module 16 intercepts statuses of data communications from the wireless transceiver module 14. Examples of the statuses of the data communications include an accumulated package amount, a signal quality indicator, transmission strength, etc. In addition, the calculation module 16 generates a display instruction according to such intercepted information for operating the display module 18 so that the display module 18 shows instant communication statuses of the wireless transceiver module 14.

There are various kinds of embodiments of the wireless transceiver module 14, the calculation module 16, and the display module 18. Exemplary embodiments are described as follows.

First preferred embodiment

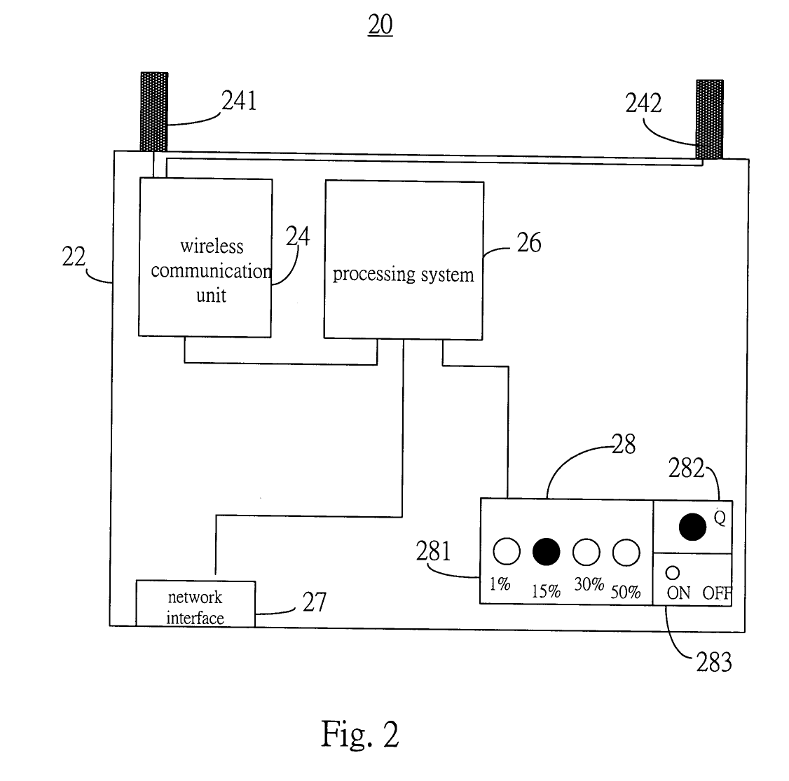

FIG. 2 is a schematic diagram of a first embodiment according to the present application. A wireless gateway 20 includes a wireless communication unit 24, a processing system 26, and display unit 28 and a network interface 27. In addition, the wireless gateway 20 has a housing 22 for installation of above-mentioned elements.

Under different communication protocols, e.g. IEEE 802.11a/b/g, the wireless communication unit 24 receives and transmits data of different communication protocols. The network interface 27 provides an interface for coupling to a wire network. The wireless gateway 20 utilizes the processing system 26 to provide data communication in the wireless communication unit 24, the network interface 27, and between the wireless communication unit 24 and the network interface 27. The processing system 24 can be implemented by firmware, software, hardware, various combinations thereof, or machines with normal Von Neumann architecture.

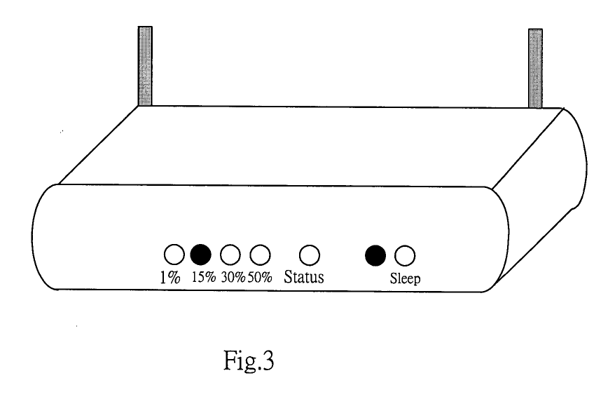

The housing 22 has different designs according to different requirements. FIG. 3 shows one example of the housing 22. However, the scope of the present invention is not limited to this shape.

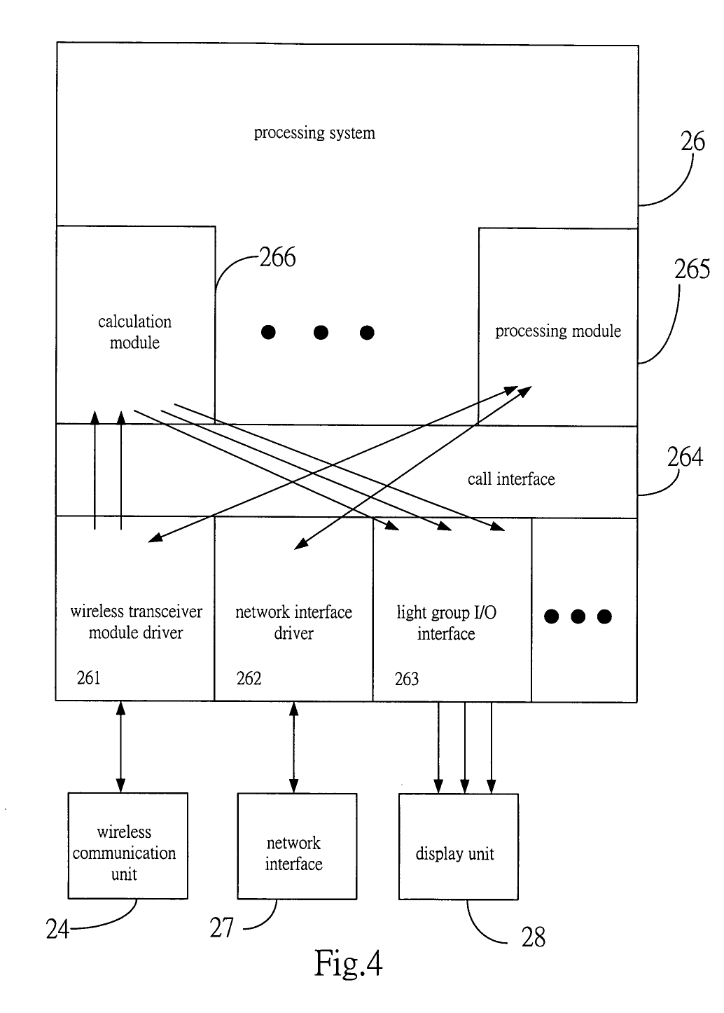

FIG. 4 is a internal operation diagram of the processing system 26. The processing system 26 includes a wireless transceiver module driver 261, a network interface driver 262, and a light group I/O interface 263 corresponding to the wireless communication unit 24, the network interface 27, and the display unit 28 respectively. A processing module 265 accesses the wireless transceiver module driver 261 and the network interface driver 262 via a call interface 264 for performing data transmission in the gateway 20.

In addition, the processing system 26 further includes a calculation module 266 that accesses status information in the wireless transceiver module driver 261. Then, the processing system 26 processes the status information and operates a display unit 28 for presenting visual information via the call interface face 264 and the light group I/O interface 263 so that instant statusof the gateway 20 are displayed.

For example, the wireless transceiver module driver 261 utilizes a variable A for accumulating a packet amount transmitted by the wireless unit 24. Such variable A can be placed in specific register or memory.

The calculation module 266 obtains a value of the variable A via the call interface 264 and the wireless transceiver module driver 261. In addition, the calculation module 266 divides the difference of values of the variable A at two timing points by an interval between the two timing points so that a flow rate is obtained. For example, the calculation module 266 acquires a value of the variable A in every second, minuses a value of the variable A at previous second so that a transmission flow rate per second is obtained, namely packet traffic.

After calculating the packet traffic, the calculation module 266 acquires a parameter in the wireless transceiver module driver 261 to recognize a communication protocol currently adopted by the wireless transceiver module driver 261 so that a maximum transmission speed of the communication protocol is obtained. An instant flow ratio is acquired by dividing the packet traffic by the maximum transmission speed of the communication protocol. For example, if the packet traffic is 1.1Mbps and the transmission protocol is IEEE 802.11b with a maximum transmission speed of 11Mbps, thenthe instant flow ratio is 5% under half-duplex mode.

In this example, the display unit 28 has four lights corresponding to four instant ratios 1%, 15%, 30%, and 50%, respectively. The light group I/O interface 263, therefore, drives corresponding light 281 via the call interface 264 after the calculation module 266 calculates the instant flow ratio. With the lights 281, users are able to realize instant network flow information. In addition, a network administrator quickly finds network congestion and adopts corresponding reactions.

In addition, the gateway 20 may switch to a sleep mode when data flow is under certain condition so that electromagnetic waves do not harm human beings. In the sleep mode, namely, no external electronic device connected to the wireless communication device 10, the wireless communication unit 24 does not broadcast beacon. The wireless communication unit 24 re-sends a beacon signal if any electronic device sends a transmission request to the wireless communication unit 24. The beacon is a service signal broadcasted by a wireless access point periodically so that client electronic devices are able to realize the existence of the wireless access point nearby.

To provide the sleep mode, the calculation mode 266 detects if the wireless communication unit 24 is in a sleep mode by referencing the wireless transceiver module 261. For example, if a parameter flag is set when the wireless communication unit 24 enters the sleep mode, the sleep mode of the wireless communication unit 24 is detected by checking the parameter flag. Another approach is to configure a program logic in the calculation module 266 and the program logic sets the wireless transceiver module driver 261 to the sleep mode when no packet is transmitted by the wireless communication unit 24 over a predetermined interval. At the same time, the calculation module 266 turns on the sleep mode light 283 to notify users the wireless communication device is in sleep mode.

Another application is that the calculation module 266 retrieves a signal quality indicator of the wireless transceiver module 261, e.g. RSSI (Received Signal Strength Indication) or RSQI (Received Signal Quality Indication). After receiving the signal quality indicator, the calculation module 266 interprets the signal quality indicator to a corresponding quality instruction and utilizes a quality light 282 of the display unit 28 according to the quality instruction so that the signal quality of the wireless communication device is displayed.

One quality light 282 can represent multiple statuses. For example, statuses of best, good, bad, and poor correspond to off, slow blinking, quick blinking, and full on of the quality light 282, and vice versa. In addition, with the help of quality light 282, users are able to adjust location and direction of an antenna of the wireless communication device so that a best transmission quality is obtained.

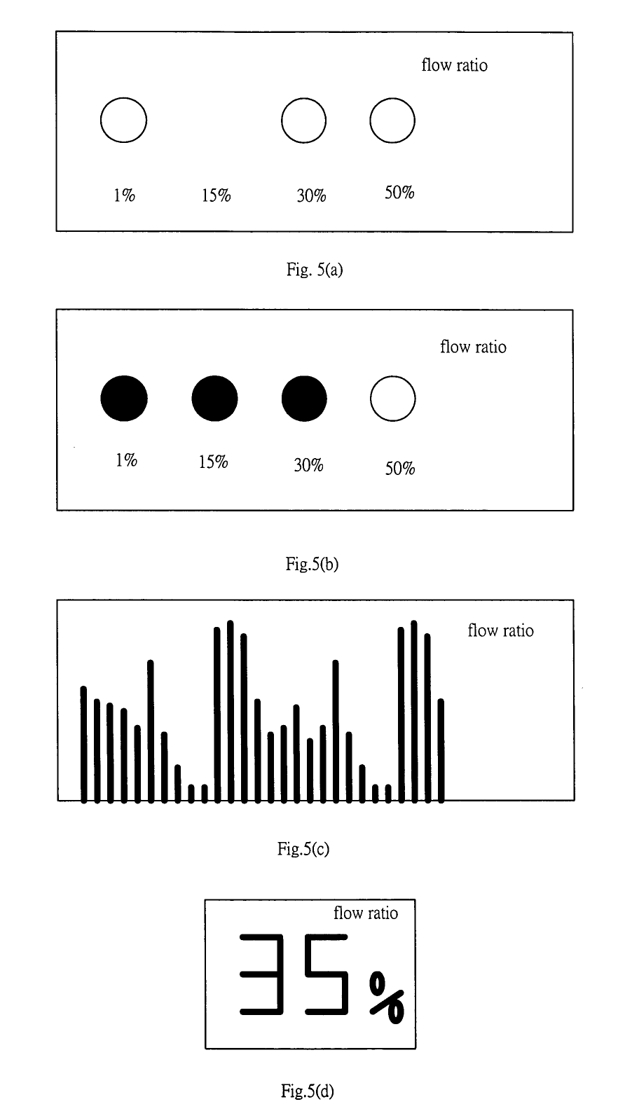

FIG. 5(a)-(d) depicts different variations of the display light group; however, these variations are not to be construed as limitations on the scope of the present invention. In FIG. 5(a), only one light corresponding to the flow ratio is turned on. In FIG. 5(b), all lights representing less or equal to the flow ratio are turned on. FIG. 5(c) depicts another bar display device for presenting instant flow ratio of communication. FIG. 5(d) shows instant communication flow ratio directly by numbers.

Second preferred embodiment

This embodiment is similar to the first preferred embodiment, and the difference is that the wireless communication unit of this embodiment utilizes a network card incorporating both IEEE802.11b and IEEE802.11g. Because IEEE802.11g is compatible with IEEE 802.11b, a network card of IEEE 802.11g can be utilized in 802.11 b. An IEEE 802.11 b/g network card, therefore, can be utilized in the gateway 20 as shown in FIG. 2 so that transmission data of these two protocols are processed at the same time.

In this example, wireless communication unit 24 automatically detects if there is any electronic device of 802.11b. If there is any electronic device of 802.11b, the wireless communication unit 24 switches the maximum transmission speed to 11 Mbps. Otherwise, the wireless communication unit 24 switches the maximum transmission speed to 54Mbps. In other words, the gateway 20 adopts 11 Mpbs as the maximum transmission speed if electronic devices of 802.11g and 802.11b are around, and therefore, the basis for calculating the instant flow ratio is the same.

In such a case, the calculation module 266 acquires the maximum transmission speed as 11Mbps or 54Mbps via the wireless transceiver module driver 261 and sets the acquired maximum transmission speed as the basis for calculating the instant flow ratio as mentioned above. With such method, only one group of lights 281 is necessary for representing both communication statuses of 802.11b and 802.11g.

Third preferred embodiment

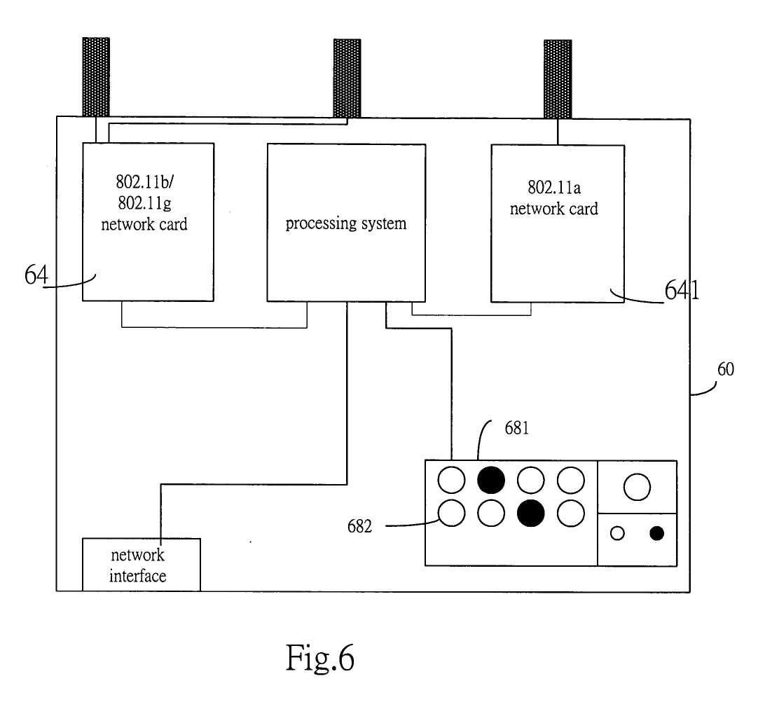

FIG. 6 shows a gateway 60 of another embodiment. The gateway 60 utilizes a network card 64 of IEEE 802.11b/g and a network card 641 of IEEE 802.11a. Because 802.11a and 802.11b/g utilize different transmission frequencies, two groups of instant transmission lights 681, 682 are installed. However, flow ratios of the two network cards 64, 641 can be presented by one group of light by combining flow ratios of the two network cards 64, 641 using a predetermined function, e.g. a weighted average function.

Accordingly, there are at least following advantages of the present invention. Firstly, the present invention provides instant presentation of communication statuses so that administrators can adopt a responding reaction, which is particularly useful in wireless network environment. Secondly, the display mechanism of the present invention is inexpensive. Thirdly, the present invention is very flexible for incorporating other mechanism or being implemented in various architectures. For example, the sleep status and the signal quality are integrated in a single display device to add value to wireless communication devices.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An wireless communication device with status display comprising:
a housing;
at least one wireless transceiver module installed in the housing for receiving and transmitting a plurality of data;
a calculation module coupled to the wireless transceiver for intercepting the plurality of data and generating a display instruction; and
a display module coupled to the calculation module for displaying at least one communication status of the wireless communication device according to the display instruction.

2. The wireless communication device of claim 1, wherein the calculation module intercepts an amount of the plurality of data for calculating an instant flow, and generates the display instruction to drive a display module showing a instant flow status of the wireless communication device.

3. The wireless communication device of claim 2, wherein the instant flow ratio is a ratio status showing the instant flow corresponding to a transmission bandwidth, wherein the transmission bandwidth follows a wireless communication protocol.

4. The wireless communication device of claim 1, wherein the display module has at least one electronic optical component showing the communication status.

5. The wireless communication device of claim 1, wherein the calculation module intercepts a signal quality indicator of the plurality of data for generating the display instruction and drives the display module to show a signal quality status of the wireless communication device.

6. The wireless communication device of claim 1, wherein the calculation device determines whether the wireless communication device enters a sleep mode according to a flow amount of the plurality of data in a predetermined interval and generates the display instruction to drive the display module showing a sleep status of the wireless communication device.

7. The wireless communication device of claim 1, wherein the calculation module is a firmware, and the firmware retrieves regularly the plurality of data from the wireless transceiver module via a program interface.

8. The wireless communication device of claim 1, further comprising:
a network interface, coupled to a wire network; and
a processing module coupled to the network interface for providing data transmission between the wire network and the wireless transceiver module.
